(19) United States
(12) Patent Application Publication
(10) Pub. No.: US 2013/0074108 A1
(43) Pub. Date: Mar. 21, 2013

(54) Seatback Video Display Unit Wireless Access Points for Inflight Entertainment System

(71) Applicants: Douglas Cline, Long Beach, CA (US); Gregory C. Petrisor, Los Angeles, CA (US)

(72) Inventors: Douglas Cline, Long Beach, CA (US); Gregory C. Petrisor, Los Angeles, CA (US)

(21) Appl. No.: 13/621,323

(22) Filed: Sep. 17, 2012

Related U.S. Application Data
(60) Provisional application No. 61/573,986, filed on Sep. 15, 2011.

(51) Int. Cl. H04N 21/40

(52) U.S. Cl. 725/5; 725/25

(57) ABSTRACT

An IFE system includes seatback VDUs having dedicated wireless access points to which airline passengers can connect using mobile client devices and access an IP network infrastructure. The seatback VDUs are configured to receive requests from passengers to access the IP network infrastructure via the dedicated wireless access points, activate the wireless access points and output access credentials, and the dedicated wireless access points are configured to receive from mobile client devices the access credentials and validate the access credentials whereupon the mobile client devices are authorized to access the IP network infrastructure via the wireless access points.

### CROSS-REFERENCE TO RELATED APPLICATION

This application claims the benefit of U.S. provisional application No. 61/573,986 entitled “SEATBACK VIDEO DISPLAY UNIT WIRELESS ACCESS POINTS FOR INFLIGHT ENTERTAINMENT SYSTEM,” filed on Sep. 15, 2011, the contents of which are incorporated herein by reference.

### BACKGROUND OF THE INVENTION

Inflight entertainment (IFE) systems have evolved significantly over the last 25 years. Prior to 1978, IFE systems consisted of audio-only systems. In 1978, Bell and Howell (Avicom Division) introduced a group viewing video system based on VHS tapes. In 1988, Airvision introduced the first in-seat video system allowing passengers to choose among several channels of broadcast video. In 1997, Swissair installed the first interactive video on demand (VOD) system. Currently, many IFE systems provide VOD with full digital video disc (DVD)-like passenger controls.

Although IFE systems vary in terms of architecture, IFE systems typically have head end equipment that serves content via a distribution network to seatback video display units (VDUs) at each passenger seat.

In recent years, airlines have begun to add Internet connectivity to their IFE systems. In one implementation, IEEE 802.11 wireless local area network (WLAN) access points have been deployed along the ceiling of aircraft. The number of deployed WLAN access points has varied from as few as two in a narrow body aircraft to six or more in a wide body aircraft. Passengers have accessed the Internet and/or onboard intranet from carry-on mobile client devices having web browsers, such as a notebook computers, tablet computers and smart phones, by connecting to the WLAN access points over wireless links.

Unfortunately, ceiling-mounted WLAN access point deployments have added substantially to the footprint of IFE systems as such deployments have required additional line replaceable units (LRUs) (namely, the WLAN access points) and wiring to support these LRUs. Moreover, as WLAN access point density inevitably increases in these deployments to accommodate increasing bandwidth demands, so too will the IFE system footprint. Furthermore, these deployments potentially subject passengers and crew to high levels of radio frequency (RF) exposure and can interfere with flight critical instruments.

It is also known in IFE systems to connect passenger control units (PCUs) that are integral or removably coupled to passenger armrests, to seatback VDUs using wireless networking protocols, such as IEEE 802.11 and Bluetooth. These PCUs are peripheral devices that allow passengers enter commands to control their personal IFE environment (e.g., volume control, channel control, reading light control, flight attendant call button control, selection of IFE system menu screens and menu items displayed on VDUs). However, these PCUs are not mobile client devices that allow passengers to conduct Transmission Control Protocol/Internet Protocol (TCP/IP) web browsing sessions with servers on the Internet or onboard intranet over the wireless connections.

### SUMMARY OF THE INVENTION

The present invention provides an IFE system in which seatback VDUs have dedicated wireless access points to which airline passengers can connect using mobile client devices and access an IP network infrastructure. The present invention further provides a method for connecting to dedicated wireless access points in such an IFE system.

In one aspect of the invention, a method for connecting to an IP network infrastructure via an IFE system comprises the steps of receiving by a seatback VDU a request to access the IP network infrastructure via a wireless access point dedicated to the seatback VDU, outputting by the seatback VDU an access credential in response to the request, receiving by the wireless access point from a mobile client device the access credential and validating by the wireless access point the access credential, whereupon the mobile client device is authorized to access the IP network infrastructure via the wireless access point.

In some embodiments, the method further comprises the steps of receiving by the seatback VDU payment information and validating by the seatback VDU the payment information prior to outputting by the seatback VDU the access credential.

In some embodiments, the method further comprises the step of activating by the seatback VDU the wireless access point in response to the request.

In some embodiments, the method further comprises the step of configuring the mobile client device for IP network access using a Dynamic Host Configuration Protocol (DHCP) server in the IP network infrastructure.

In some embodiments, the method further comprises the step of conducting by the mobile device a TCP/IP web browsing session with a server in the IP network infrastructure.

In some embodiments, the server is on an aircraft.

In some embodiments, the server is on a terrestrial network reached over an aircraft-to-ground wireless link.

In some embodiments, the wireless access point is integral to the seatback VDU.

In some embodiments, the wireless access point is on a module inserted into a module receiving area of the seatback VDU.

In some embodiments, the wireless access point is on a module tethered to the seatback VDU by a networking cable.

In some embodiments, the request is inputted on a touch screen of the seatback VDU.

In some embodiments, the access credential is outputted on a display of the seatback VDU.

In some embodiments, the IFE system comprises a plurality of seatback VDUs associated with a respective plurality of wireless access points dedicated to the seatback VDUs, wherein wireless access points associated with adjacent seatback VDUs in a single row of an aircraft communicate with respective mobile client devices on non-overlapping radio frequencies.

In some embodiments, the IFE system comprises a plurality of seatback VDUs associated with a respective plurality of wireless access points dedicated to the seatback VDUs, wherein wireless access points associated with non-adjacent seatback VDUs in a single row of an aircraft communicate with respective mobile client devices on a common radio frequency.

In some embodiments, the IFE system comprises a plurality of seatback VDUs associated with a respective plurality of wireless access points dedicated to the seatback VDUs, wherein wireless access points associated with seatback VDUs in different rows of an aircraft communicate with respective mobile client devices on a common radio frequency.

In some embodiments, the mobile client device is a notebook computer.

In some embodiments, the mobile client device is a tablet computer.

In some embodiments, the mobile client device is a smart phone.

In some embodiments, the wireless access point is a WLAN access point.

In some embodiments, the wireless access point is a Bluetooth access point.

In another aspect of the invention, an IFE system comprises head end equipment and a plurality of seatback VDUs communicatively coupled with the head end equipment, wherein the seatback VDUs are configured to receive requests to access an IP network infrastructure via wireless access points dedicated to the seatback VDUs and output access credentials in response to the requests, and wherein the dedicated wireless access points are configured to receive from mobile client devices the access credentials and validate the access credentials, whereupon the mobile client devices are authorized to access the IP network infrastructure via the wireless access points.

These and other aspects will be better understood by reference to the following detailed description taken in conjunction with the drawings that are briefly described below. Of course, the invention is defined by the appended claims.

### BRIEF DESCRIPTION OF THE DRAWINGS

FIG. 1 shows an IFE system having seatback VDUs with dedicated wireless access points.

FIG. 2 shows a fiber optic IFE system having seatback VDUs with dedicated wireless access points.

FIG. 3 shows a dedicated wireless access point integral with a seatback VDU.

FIG. 4 shows a dedicated wireless access point on a module insertable into a module receiving area of a seatback VDU.

FIG. 5 shows a dedicated wireless access point tethered to a seatback VDU via a networking cable.

FIG. 6 shows operational elements of a mobile client device.

FIG. 7 shows a method for connecting to an IP network infrastructure through a wireless access point dedicated to a seatback VDU in an IFE system.

### DETAILED DESCRIPTION OF A PREFERRED EMBODIMENT

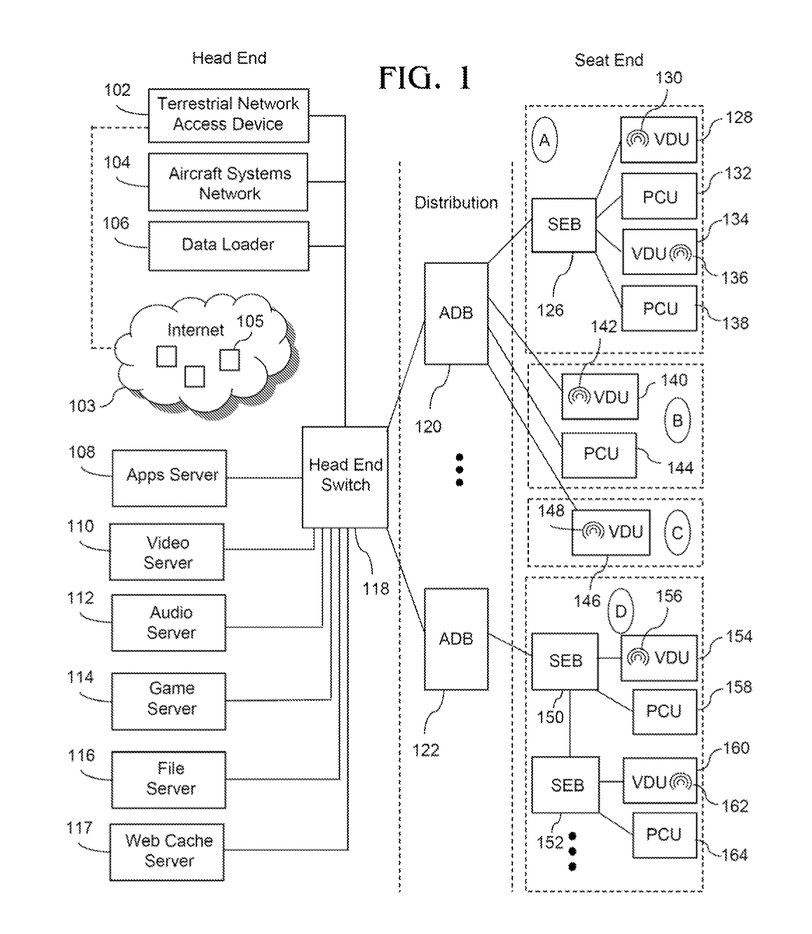

FIG. 1 shows an IFE system having seatback VDUs with dedicated wireless access points in some embodiments of the invention. The IFE system is deployed on an aircraft, such as a regional or jumbo jet. Elements of this IFE system are summarized below and may be implemented in software under microprocessor control, custom circuitry, or a combination thereof.

The IFE system includes the following head end equipment: a terrestrial network access device 102, an aircraft systems network 104, a data loader 106, an applications server 108, a video server 110, an audio server 112, a game server 114, a file server 116, a web cache server 117 and a head end switch 118.

Terrestrial network access device 102 provides connectivity to the Internet 103 over an air-to-ground wireless link, which may be direct link or a satellite link. Access device 102 has an offboard wireless network interface that provides the IFE system with an uplink and downlink to the Internet 103 for data exchange with terrestrial servers 105. Access device 102 also has an onboard wired network interface connected to a head end switch 118 via a networking cable.

Head end servers 108, 110, 112, 114, 116, 117 and terrestrial servers 105 support TCP/IP web browsing sessions with mobile client devices.

Aircraft systems network 104 provides the IFE system with access to content and data such as reading light control, flight attendant calling and flight information for applications such as flight progress maps. Aircraft systems network 104 is connected to head end switch 118 via a networking cable.

Data loader 106 facilitates loading of content on head end servers 108, 110, 112, 114, 116, 117, key updates and transaction data transfers. Data loader 106 acquires a library of prerecorded entertainment programs through a removable disk or tape inserted into data loader 106, a portable disk drive or tape drive temporarily connected to head end servers 108, 110, 112, 114, 116, 117, or upload via access device 102, a WLAN and/or other wireless link. The content library may also include popular web pages. The content library is typically acquired while the aircraft is on the ground and may be updated while the aircraft is in flight. The content library includes, for example, movies, television (TV) shows, video games, audio programs and web pages. The content library is stored on head end equipment across head end servers 108, 110, 112, 114, 116, 117. Data loader 106 is connected to head end switch 118 via a networking cable.

Applications server 108 has a DHCP server for facilitating dynamic host configuration of mobile client devices. Applications server 108 also facilitates content management, channel packaging, transaction processing, billing system integration, services management, provisioning integration, system administration and management, encryption management (e.g., key servers, authentication, etc.), software client management and server integration. Applications server 108 is connected to head end switch 118 via a networking cable.

Video server 110 provides VOD, near-VOD, pay-per-view, network personal video recorder and broadcast video services. In some embodiments, video server 110 and audio server 112 are integrated into a single audio/video on demand server. Video server 110 is connected to head end switch 118 via a networking cable.

Audio server 112 provides audio on demand and broadcast audio services. Audio server 112 is connected to head end switch 118 via a networking cable.

Game server 114 provides logic, programming and dynamically delivered web pages for browser-based games. Game server 114 is connected to head end switch 118 via a networking cable.

File server 116 maintains network administration data, such as user data and user profile data. File server 116 is connected to head end switch 118 via a networking cable.

Web cache server 117 provides onboard caching of web pages retrieved pursuant to requests made by passengers in TCP/IP web browsing sessions initiated on mobile client devices accessing the Internet 103 via wireless access points dedicated to seatback VDUs.

Head end switch 118 interconnects head end equipment with area distribution boxes (ADBs) 120, 122 over networking cables.

While FIG. 1 refers to elements of head end equipment in the singular (e.g., “video server”, “head end switch”, etc.), head end equipment may include multiple instances of such elements.

Between the head end equipment and seat end equipment is a distribution system including ADBs 120, 122. ADBs 120, 122 have network interfaces and interconnect head end switch 118 and seat end equipment over network cables. ADBs 120, 122 provide signal regeneration and distribution of data.

Seat end equipment includes seat end LRUs, including seat electronics boxes (SEBs) 126, 150, 152, VDUs 128, 134, 140, 146, 154, 160 and/or PCUs 132, 138, 144, 158 and 164, in various arrangements.

Callout boxes A through D in FIG. 1 show different seat end equipment arrangements. A given IFE system deployment on an aircraft may use one or more of the illustrated arrangements.

In the arrangement shown in Callout Box A, ADB 120 is connected between head end switch 118 and SEB 126. ADB 120 distributes data to SEB 126 which generates raw pixel data that is fed to VDUs 128, 134. SEB 126 also generates raw audio and relays control data to PCUs 132, 138.

In the arrangement shown in Callout Box B, ADB 120 is connected directly to VDU 140 and PCU 144. In this arrangement, the data processing performed by SEB 126 in Callout Box A is integrated into VDU 140 and PCU 144.

In the arrangement shown in Callout Box C, ADB 120 is connected directly to VDU 146. In this arrangement, data processing performed by SEB 126 is integrated into VDU 146. Moreover, the passenger interface provided by PCU 144 is integrated into VDU 146. For example, VDU 146 provides a touch screen for receiving passenger input and an audio jack for transmitting audio output.

In the arrangement shown in Callout Box D, ADB 122 is connected to SEB 150. ADB 122 distributes data to SEB 150 which generates raw pixel data that is fed to VDU 154. SEB 150 also generates raw audio and relays control data to PCU 158. Moreover, SEB 150 distributes data to SEB 152 in an adjacent seat group in the same seat column over an additional network cable. A seat group typically includes three seats mounted to the same structure. SEB 152 generates raw pixel data and raw audio that is fed to VDU 160 and PCU 164.

SEBs 126, 150, 152 are seat end LRUs mounted under passenger seats. SEBs 126, 150, 152 have network interfaces and processors for seat groups. Each SEB supports three seats corresponding to a three-seat seat group.

VDUs 128, 134, 140, 146, 154, 160 are seat end LRUs mounted to the back of passenger seats. VDUs 128, 134, 140, 146, 154, 160 have a physical display (e.g., flat panel display) for displaying video content and IFE system menus. Moreover, some VDUs include electronics that were previously located in SEBs in order to reduce the size of SEBs. For example, Callout Box B shows an arrangement where VDU 140 is connected directly to ADB 120. VDU 140 provides SEB-type processing in this arrangement. Callout Box C shows another arrangement where VDU 146 is connected directly to ADB 120. In this arrangement, VDU 146 provides SEB-type processing as well as a passenger interface conventionally provided by a PCU. For example, VDU 146 provides a touch screen for receiving user input and an audio jack for transmitting audio output.

VDUs 128, 134, 140, 146, 154, 160 have dedicated wireless access points 130, 136, 142, 148, 156, 162, respectively, which may be integral to VDUs 128, 134, 140, 146, 154, 160, resident on a module inserted into a module receiving area of VDUs 128, 134, 140, 146, 154, 160 or tethered to VDUs 128, 134, 140, 146, 154, 160 by networking cables (e.g., IEEE 802.3 Ethernet cables). It bears noting that there is a one-to-one correspondence between wireless access points 130, 136, 142, 148, 156, 162 and VDUs 128, 134, 140, 146, 154, 160. Accordingly, each passenger has an opportunity to connect to a wireless access point on an exclusive basis.

Wireless access points 130, 136, 142, 148, 156, 162 may be, for example, WLAN access points or Bluetooth access points. Wireless access points 130, 136, 142, 148, 156, 162 authenticate mobile client devices carried on board by passengers and support TCP/IP web browsing sessions between authenticated mobile client devices and an IP network infrastructure including terrestrial servers 105 on the Internet 103 and/or head end servers 109, 110, 112, 114, 116, 117 on the onboard intranet.

PCUs 132, 138, 144, 158, 164 are seat end LRUs that are typically fixed-mounted or tethered to passenger armrests. PCUs 132, 138, 144, 158, 164 are peripheral devices that allow passengers to control their personal IFE environment by entering commands on a user interface of PCUs 132, 138, 144, 158, 164 (e.g., volume control, channel control, reading light control, flight attendant call button control, selection of IFE system menus and menu items displayed on VDU, etc.).

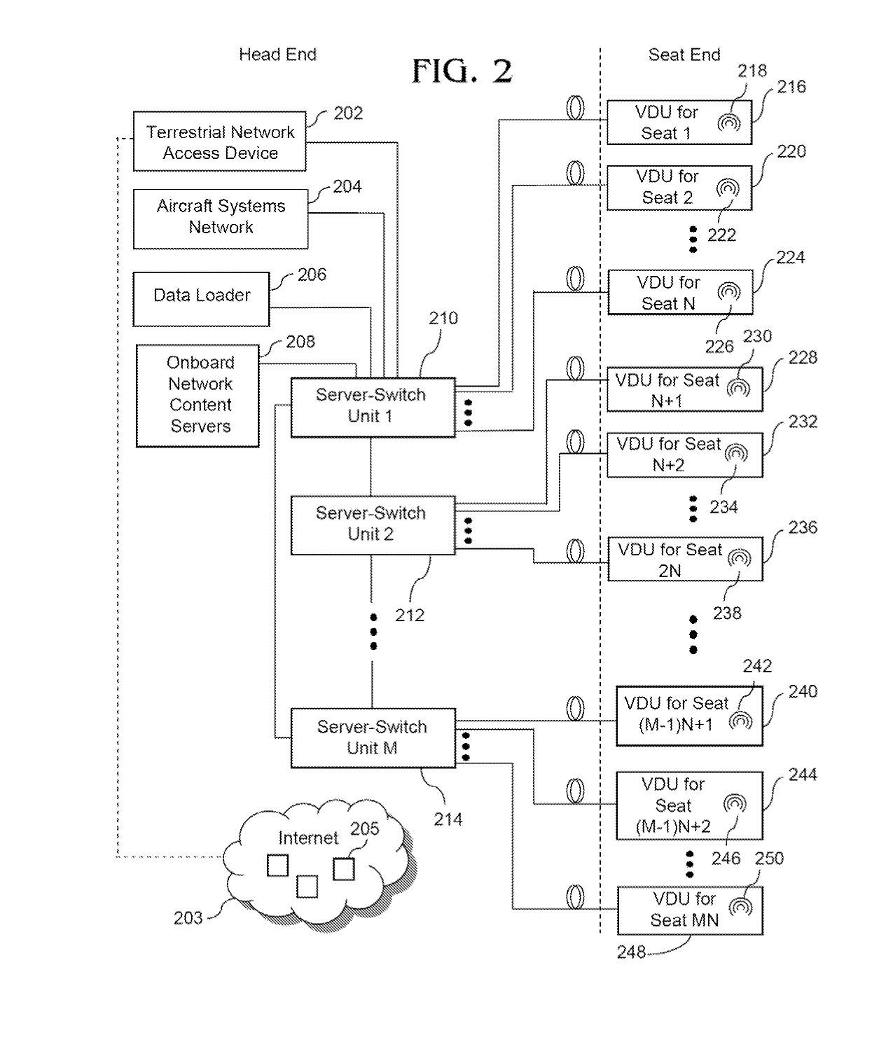

FIG. 2 shows a fiber optic IFE system in some embodiments of the invention. In this IFE system, integrated server-switch units (SSUs) 210, 212, 214 are interconnected with one another via fiber optic network cables to form an aggregate head end server-switch system. A terrestrial network access device 202 and an aircraft systems network 204 at the head end are connected directly to one or more of SSUs 210, 212, 214 via networking cables. In addition, a data loader 206 at the head end is connected directly to SSUs 210, 212, 214 via networking cables. VDUs 216, 220, 224, 228, 232, 236, 240, 244, 248 are seat end LRUs mounted to the back of passenger seats, have dedicated wireless access points 218, 222, 226, 230, 234, 238, 242, 246, 250, respectively, and are connected directly to ones of SSU 210, 212, 214 via fiber optic networking cables. Wireless access points 218, 222, 226, 230, 234, 238, 242, 246, 250 may be integral to VDUs 216, 220, 224, 228, 232, 236, 240, 244, 248, resident on modules inserted into module receiving areas of VDUs 216, 220, 224, 228, 232, 236, 240, 244, 248 or tethered to VDUs 216, 220, 224, 228, 232, 236, 240, 244, 248 over networking cables. In the fiber optic IFE system of FIG. 2, server functionality (e.g., application server, audio server, video server, game server, file server, etc.) is integrated into SSUs 210, 212, 214 and seat end equipment consists in only VDUs 216, 220, 224, 228, 232, 236, 240, 244, 248 and associated wireless access points 218, 222, 226, 230, 234, 238, 242, 246, 250.

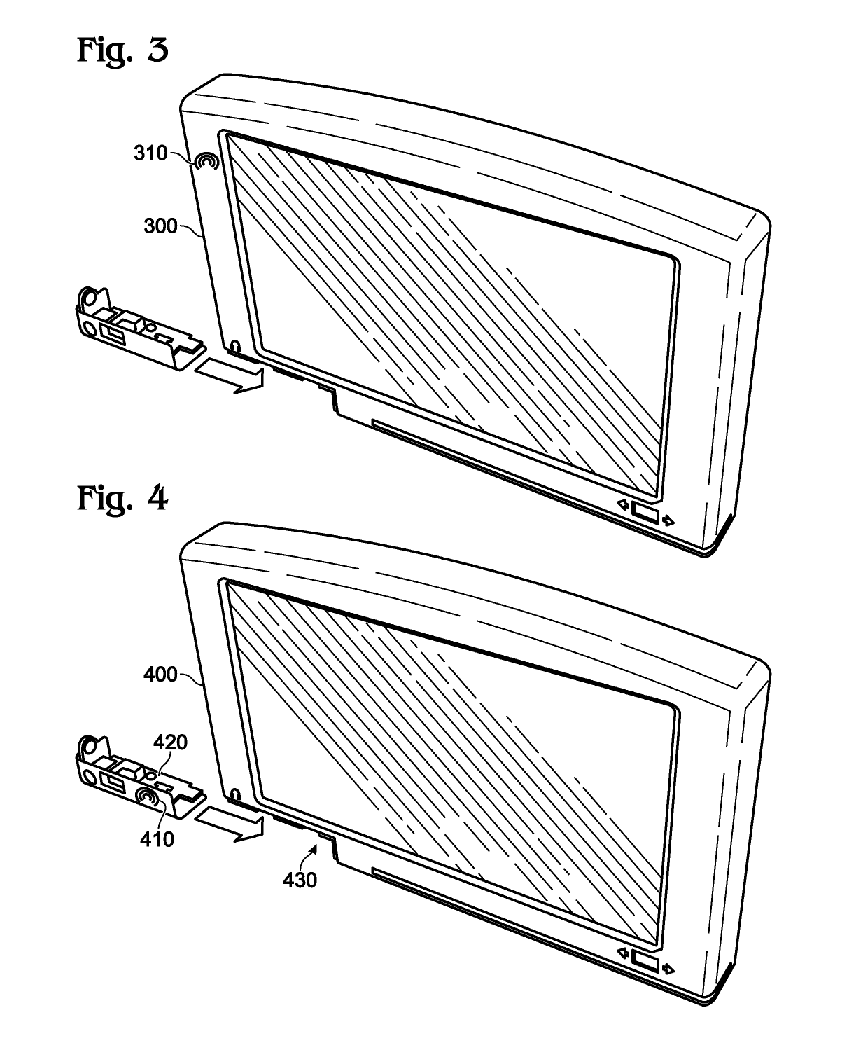

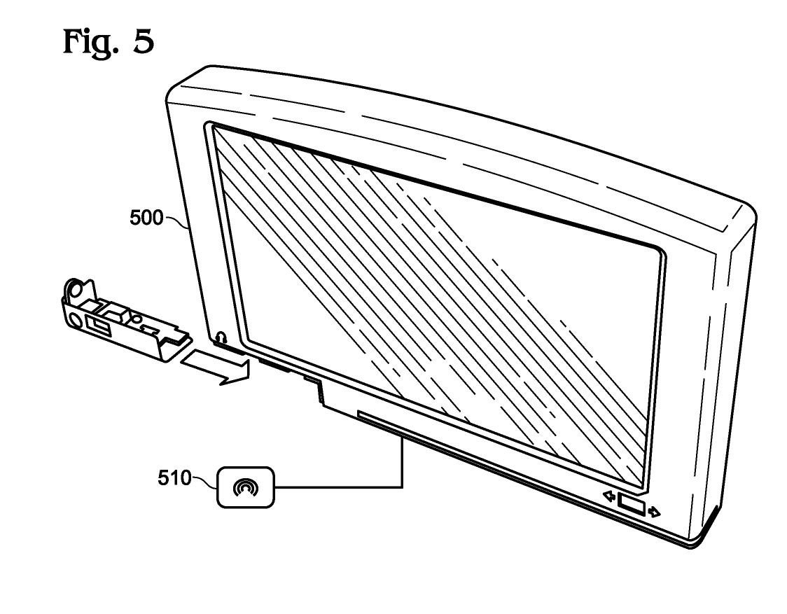

FIGS. 3-5 show various options for associating a dedicated wireless access point with a seatback VDU. In FIG. 3, a wireless access point 310 is integral with seatback VDU 300. In FIG. 4, a wireless access point 410 is deployed on a module 420 insertable into a module receiving area 430 of a seatback VDU 400. In FIG. 5, a wireless access point 510 is tethered to a seatback VDU 500 over a networking cable. An IFE system deployment on an aircraft may use any one or more of these associating arrangements.

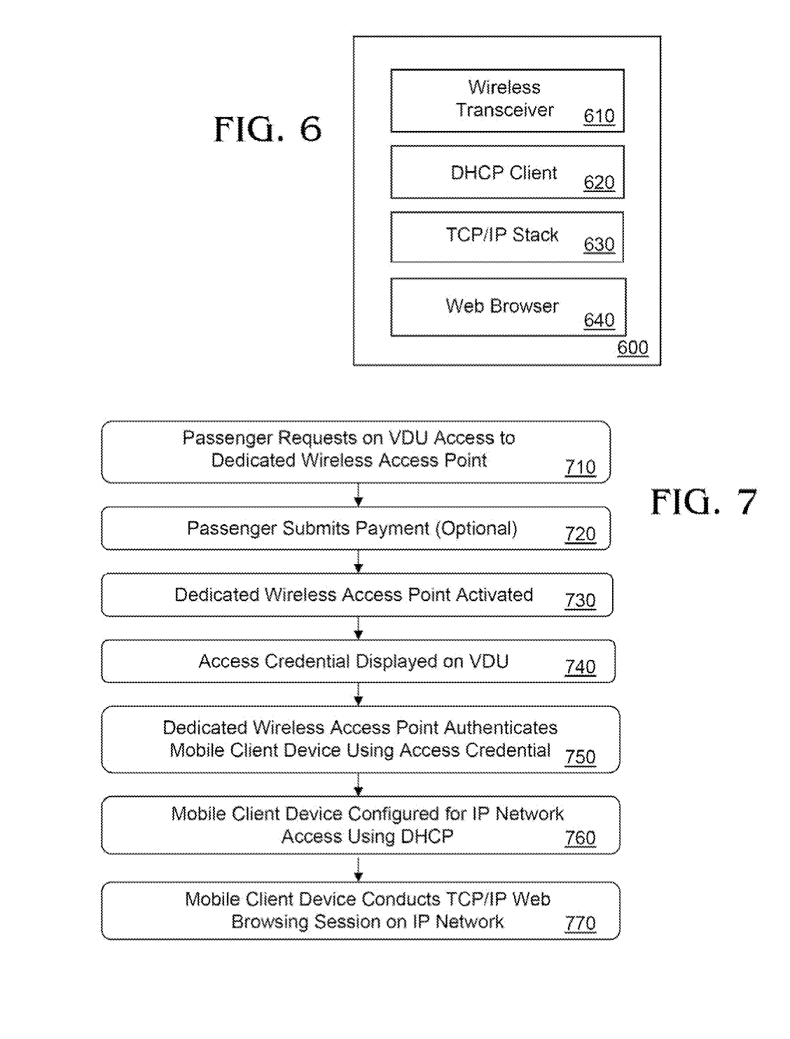

FIG. 6 shows operational elements of a mobile client device 600. Mobile client device 600 includes a wireless transceiver 410, such as an WLAN or Bluetooth transceiver, which enables mobile client device 600 to connect with one of wireless access points 130, 136, 142, 148, 156, 162 and become authenticated. Mobile client device 600 further includes a DHCP client 620, which enables mobile client device 600 after becoming authenticated to contact a DHCP server (e.g., on applications server 108) and become configured as an IP host (e.g., obtain a dynamic IP address). Mobile client device 600 further includes TCP/IP stack 630 and a web browser 640 that enable mobile client device 600 after becoming configured as an IP host to conduct TCP/IP web browsing sessions with servers in the IP network infrastructure, including servers 105 on the Internet 103 and head end servers 108, 110, 112, 114, 116, 117 on the onboard intranet. Mobile client device 600 may be a notebook computer, tablet computer or smart phone, by way of example.

FIG. 7 shows a method for connecting to an IP network infrastructure through a wireless access point dedicated to a seatback VDU in an IFE system. An airline passenger requests Internet and/or onboard intranet access via the dedicated wireless access point associated with his or her seatback VDU by making inputs on the seatback VDU (710). These inputs may be made on a touch screen of the seatback VDU or on a PCU mounted to the passenger's armrest, by way of example. Depending on implementation, the passenger may then be required to pay for the requested access (720). For example, the passenger may be required to swipe a credit card on the seatback VDU whereafter the credit card information is validated. The dedicated wireless access point is then activated (730), which includes powering-up and initializing the dedicated wireless access point for service. The passenger is also provided an access credential (740). In one example, the access credential may be an access code displayed on the seatback VDU. The passenger then views the access credential and inputs the access credential on his or her mobile client device. The mobile client device then transmits the access credential to the dedicated wireless access point, which validates the access credential to authenticate the mobile client device (750). At that point, the mobile client device is authorized to conduct TCP/IP web browsing sessions with servers in the IP network infrastructure via the dedicated wireless access point. However, before launching a web browsing session, the mobile client device contacts a DHCP server in the IP network infrastructure and becomes configured as an IP host (e.g., obtains a dynamic IP address) (760). The mobile client device may then start a TCP/IP web browsing session with a server in the IP network infrastructure, such as one of servers 105 on the Internet 103 or one of head end servers 108, 110, 112, 114, 116, 117 on the onboard intranet (770).

To avoid interference, wireless access points associated with adjacent seatback VDUs in a single row of an aircraft communicate with respective mobile client devices on non-overlapping radio frequencies. On the other hand, wireless access points associated with non-adjacent seatback VDUs in a single row of an aircraft may communicate with respective mobile client devices on a common radio frequency. Similarly, wireless access points associated with seatback VDUs in different rows of an aircraft may communicate with respective mobile client devices on a common radio frequency.

It will be appreciated by those of ordinary skill in the art that the invention can be embodied in other specific forms without departing from the spirit or essential character hereof. For example, certain steps described in the method of FIG. 7, such as Steps 730 and 740, may be performed in reverse order. The present description is therefore considered in all respects to be illustrative and not restrictive. The scope of the invention is indicated by the appended claims, and all changes that come with in the meaning and range of equivalents thereof are intended to be embraced therein.

What is claimed is:

1. A method for connecting to an Internet Protocol (IP) network infrastructure via an inflight entertainment (IFE) system, comprising the steps of:
receiving by a seatback video display unit (VDU) a request to access the IP network infrastructure via a wireless access point dedicated to the seatback VDU;
outputting by the seatback VDU an access credential in response to the request;
receiving by the wireless access point from a mobile client device the access credential; and
validating by the wireless access point the access credential, whereupon the mobile client device is authorized to access the IP network infrastructure via the wireless access point.

2. The method of claim 1, further comprising the steps of:
receiving by the seatback VDU payment information; and
validating by the seatback VDU the payment information prior to outputting by the seatback VDU the access credential.

3. The method of claim 1, further comprising the step of activating by the seatback VDU the wireless access point in response to the request.

4. The method of claim 1, further comprising the step of configuring the mobile client device for IP network access using a Dynamic Host Configuration Protocol (DHCP) server in the IP network infrastructure.

5. The method of claim 1, further comprising the step of conducting by the mobile device a TCP/IP web browsing session with a server in the IP network infrastructure.

6. The method of claim 5, wherein the server is on an aircraft.

7. The method of claim 5, wherein the server is on a terrestrial network reached over an aircraft-to-ground wireless link.

8. The method of claim 1, wherein the wireless access point is integral to the seatback VDU.

9. The method of claim 1, wherein the wireless access point is on a module inserted into a module receiving area of the seatback VDU.

10. The method of claim 1, wherein the wireless access point is on a module tethered to the seatback VDU by a networking cable.

11. The method of claim 1, wherein the request is inputted on a touch screen of the seatback VDU.

12. The method of claim 1, wherein the access credential is outputted on a display of the seatback VDU.

13. The method of claim 1, wherein the IFE system comprises a plurality of seatback VDUs associated with a respective plurality of wireless access points dedicated to the seatback VDUs, wherein wireless access points associated with adjacent seatback VDUs in a single row of an aircraft communicate with respective mobile client devices on non-overlapping radio frequencies.

14. The method of claim 1, wherein the IFE system comprises a plurality of seatback VDUs associated with a respective plurality of wireless access points dedicated to the seatback VDUs, wherein wireless access points associated with non-adjacent seatback VDUs in a single row of an aircraft communicate with respective mobile client devices on a common radio frequency.

15. The method of claim 1, wherein the IFE system comprises a plurality of seatback VDUs associated with a respective plurality of wireless access points dedicated to the seatback VDUs, wherein wireless access points associated with seatback VDUs in different rows of an aircraft communicate with respective mobile client devices on a common radio frequency.

16. The method of claim 1, wherein the mobile client device is a notebook computer.

17. The method of claim 1, wherein the mobile client device is a tablet computer.

18. The method of claim 1, wherein the mobile client device is a smart phone.

19. The method of claim 1, wherein the wireless access point is a wireless local area network (WLAN) access point.

20. The method of claim 1, wherein the wireless access point is a Bluetooth access point.

21. An inflight entertainment (IFE) system, comprising:
head end equipment; and
a plurality of seatback video display units (VDUs) communicatively coupled with the head end equipment, wherein the seatback VDUs are configured to receive requests to access an Internet Protocol (IP) network infrastructure via wireless access points dedicated to the seatback VDUs and output access credentials in response to the requests, and wherein the dedicated wireless access points are configured to receive from mobile client devices the access credentials and validate the access credentials, whereupon the mobile client devices are authorized to access the IP network infrastructure via the wireless access points.

22. The system of claim 21, wherein the seatback VDUs are further configured to receive payment information and validate the payment information prior to outputting the access credential.

23. The system of claim 21, wherein the seatback VDUs are further configured to activate the wireless access points in response to the requests.

24. The system of claim 21, wherein the mobile client devices are configured for IP network access using a Dynamic Host Configuration Protocol (DHCP) server in the IP network infrastructure.

25. The system of claim 21, wherein the mobile client devices are further configured to conduct TCP/IP web browsing sessions with servers in the IP network infrastructure.

26. The system of claim 25, wherein at least one of the servers is on an aircraft.

27. The system of claim 25, wherein at least one of the servers is on a terrestrial network reached over an aircraft-to-ground wireless link.

28. The system of claim 21, wherein the wireless access points are integral to the seatback VDUs.

29. The system of claim 21, wherein the wireless access points are on modules inserted into module receiving areas of the seatback VDUs.

30. The system of claim 21, wherein the wireless access points are on modules tethered to the seatback VDUs by networking cables.

31. The system of claim 21, wherein the requests are inputted on touch screens of the seatback VDUs.

32. The system of claim 21, wherein the access credentials are outputted on displays of the seatback VDUs.

33. The system of claim 21, wherein wireless access points associated with adjacent seatback VDUs in a single row of an aircraft communicate with respective mobile client devices on non-overlapping radio frequencies.

34. The system of claim 21, wherein wireless access points associated with non-adjacent seatback VDUs in a single row of an aircraft communicate with respective mobile client devices on a common radio frequency.

35. The system of claim 21, wherein wireless access points associated with seatback VDUs in different rows of an aircraft communicate with respective mobile client devices on a common radio frequency.

36. The system of claim 21, wherein at least one of the mobile client devices is a notebook computer.

37. The system of claim 21, wherein at least one of the mobile client devices is a tablet computer.

38. The system of claim 21, wherein at least one of the mobile client devices is a smart phone.

39. The system of claim 21, wherein the wireless access points are wireless local area network (WLAN) access points.

40. The system of claim 21, wherein the wireless access points are Bluetooth access points.
